(19) United States
(12) Patent Application Publication
(10) Pub. No.: US 2005/0108102 A1
(43) Pub. Date: May 19, 2005

(54) Method, apparatus, and system for verifying incoming orders

(76) Inventor: Richard York, San Jose, CA (US)

Correspondence Address: HEWLETT-PACKARD DEVELOPMENT COMPANY;Intellectual Property Administration, P.O. Box 272400, Fort Collins, CO, 80527-2400, US

(21) Appl. No.: 10/715,924

(22) Filed: Nov. 17, 2003

(51) Int. Cl. G06F 17/60

(52) U.S. Cl. 705/26

(57) ABSTRACT

An embodiment of the invention provides a method of verifying incoming orders for fraud prevention, including: assigning a risk factor with an incoming order; and providing a set of information to verify based upon the risk factor assigned to the incoming order. In another embodiment of the invention, an apparatus for verifying incoming orders for fraud prevention, includes: a server including a transaction processing module configured to process an incoming order that is received from a call center or an online shopping website, where the transaction processing module includes an incoming order verification module configured to provide a set of information to verify based upon a risk factor assigned to the incoming order.

### TECHNICAL FIELD

Embodiments of the invention relate generally to the fraud prevention methods. More particularly, embodiments of the invention relate to incoming orders verification methods.

### BACKGROUND

An incoming order (e.g., an order for a particular product or service) may be placed by a customer via an online shopping website or via a call-center. Currently, when an incoming order is made by a customer, the incoming order will be reviewed for potential fraud by having an analyst examine the dollar amount of the incoming order. As a result, this current method is unable to detect for fraudulent orders that may have lower dollar amounts.

Additionally, in current methods and systems, a fraud analyst would review incoming orders in different manners, by different methodologies, and/or by use of different criteria. As a result, there was no consistency in the fraud review process.

Therefore, the current technology is limited in its capabilities and suffers from at least the above constraints and deficiencies. Thus, it would be desirable to improve the current methods for verifying an incoming order for potential fraud before the order is accepted or rejected.

### SUMMARY OF EMBODIMENTS OF THE INVENTION

In one embodiment of the invention, a method of verifying incoming orders for fraud prevention, includes: assigning a risk factor with an incoming order; and providing a set of information to verify based upon the risk factor assigned to the incoming order. An incoming order may be associated with the risk factor of, for example, low risk, medium risk, or high risk.

In another embodiment, an apparatus for verifying incoming orders for fraud prevention, includes: a server including a transaction processing module configured to process an incoming order that is received from a call center or an online shopping website; the transaction processing module comprising an incoming order verification module configured to provide a set of information to verify based upon a risk factor assigned to the incoming order.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an apparatus in accordance with an embodiment of the invention.

FIG. 2A is a high-level flowchart illustrating a method for an initial order review workflow that may be used in an embodiment of the invention.

FIG. 2B is a flowchart illustrating additional details of a method for an initial order review workflow that may be used in an embodiment of the invention.

FIG. 3 is a flowchart illustrating which information to verify for a low risk order, a medium risk order, and a high risk order, in accordance with an embodiment of the invention.

FIG. 4 is a flowchart illustrating a method for a low risk order workflow, in accordance with an embodiment of the invention.

FIG. 5 is a flowchart illustrating a method for a medium risk order workflow, in accordance with an embodiment of the invention.

FIG. 6 is a flowchart illustrating a method for a high risk order workflow, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

Embodiments of the invention advantageously provide an apparatus, system, and method that verify particular information for an incoming order, based upon a risk factor that has been assigned to the incoming order. Embodiments of the invention advantageously provide an apparatus, system, and method that guide the fraud analyst in obtaining particular information that are required to make a logical decision on whether to approve or reject an incoming order.

In contrast, in current methods and systems, a fraud analyst would review incoming orders in different manners, by different methodologies, and/or by use of different criteria. As a result, in current methods and systems, there was no consistency in the fraud review process.

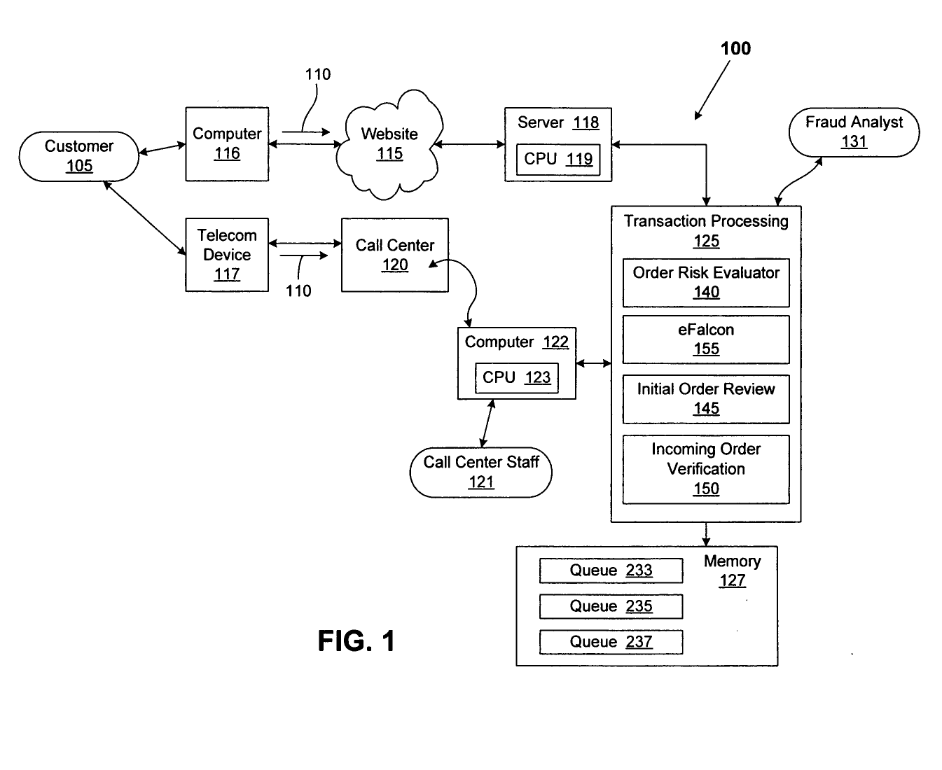

FIG. 1 is a block diagram of a system (or apparatus) 100 in accordance with an embodiment of the invention. A customer 105 may send an order 110 via an online shopping website 115 or may send the order 110 by calling a call-center 120. The order 110 may be, for example, an order for a particular product(s) and/or service(s). Typically, to send an order 110 to the online shopping website 115, the customer 105 will use a computer 116 to access and place the order 110 on the website 115. Typically, to send an order 110 to the call center 120, the customer 105 will use a telecommunication (telecom) device 117 (e.g., telephone or cellular phone) to place the order 110 to the call center 120.

The online shopping website 115 may be, for example, an online shopping website provided by HEWLETT-PACKARD COMPANY, Palo Alto, Calif., at <www.HPShopping.com>, other online shopping websites from other vendors or companies, an internal company shopping website, or another type of online shopping website.

Typically, a server 118 (or other suitable computing device) is used to implement the website 115 and to receive and process the order 110 from the customer 105. The server 118 includes a processor 119 (e.g., a central processing unit) for executing various applications or programs that are accessible by the server 118. Similarly, the customer's computer 116 will also include a processor (not shown in FIG. 1) for executing various applications or programs in the computer 116. Various known components that are used in the server 118 and in the user's computer 116 are not shown in FIG. 1 for purposes of focusing on the functionalities of embodiments of the invention.

A call center staff 121 in the call center 120 typically has access to a computer 122 for processing an incoming order 110 that is received in the call center 120. Typically, each call center staff 121 will have access to a separate computer 122. The computer 122 includes a processor 123 (e.g., a central processing unit) for executing various applications or programs that are accessible by the computer 122.

In an embodiment of the invention, a transaction processing module 125 is typically implemented within the server 118. However, the transaction processing module 125 may alternatively be implemented in another computer (not shown in FIG. 1) that is accessible by the server 118 and by the call center staff computer 122. An order risk evaluator 140 in the transaction processing module 125 can determine if the order 110 is a high risk order (i.e., an order with a high risk related to fraudulent activity), a medium risk order (i.e., an order with a medium risk related to fraudulent activity), or a low risk order (i.e., an order with a low risk related to fraudulent activity).

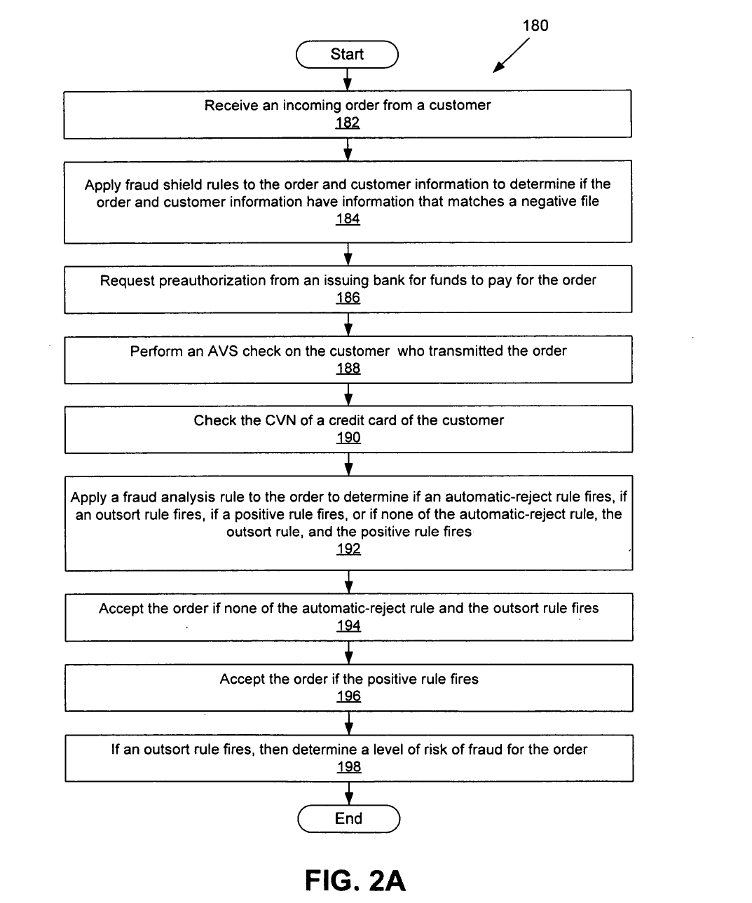

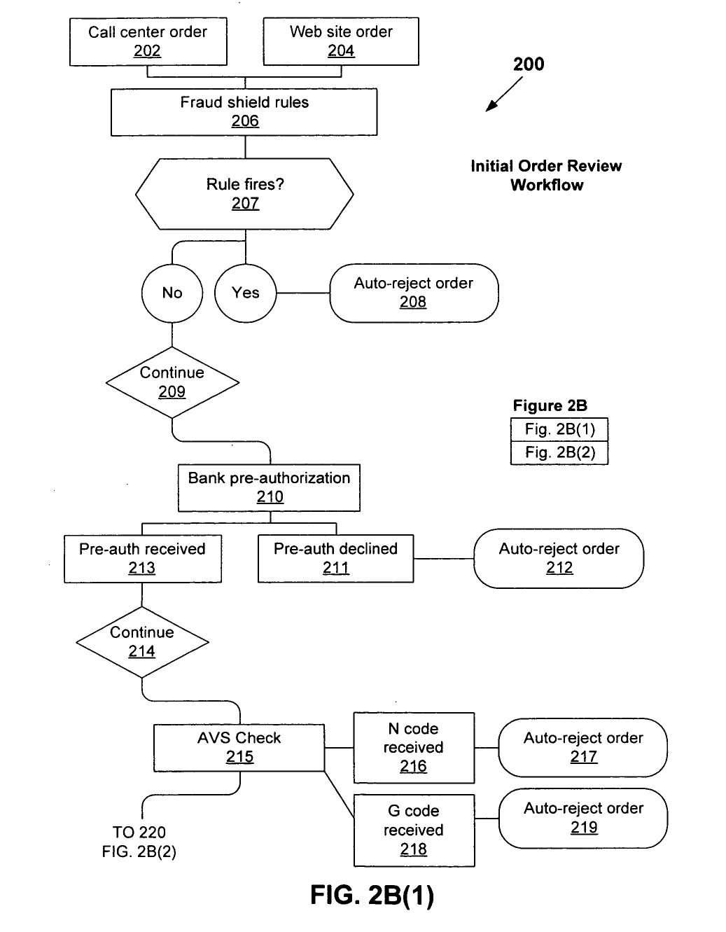

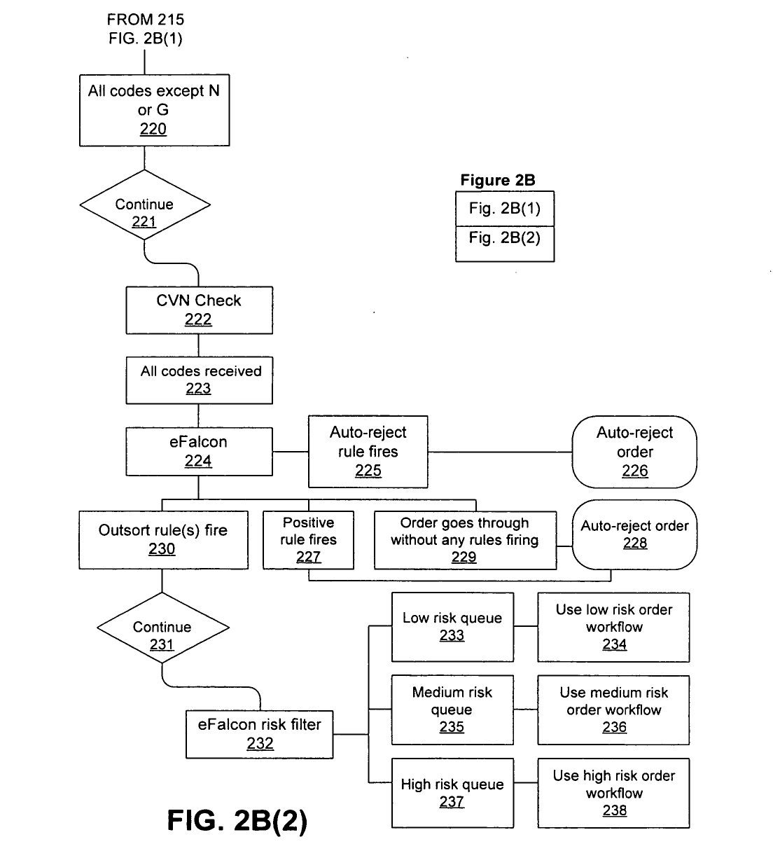

Typically, an initial order review workflow module 145 first outsorts an order 110 before the order 110 is determined as a high risk order, medium risk order, or low risk order. An order 110 is outsorted if the order 110 is selected among various incoming orders and placed in a separate queue (i.e., an outsort queue 233, 235, or 237 in FIG. 1 and FIG. 2B) where the order 110 can then be evaluated for risk related to fraudulent activity. Typically, these outsort queue 233, 235, and 237 are memory areas 126 in a memory 127. This memory 127 may be, for example, within the server 118, or within another computing device or memory storage device that can be accessed by the server 118 and call center staff computer 122.

The order risk evaluator 140 can categorize an incoming order 110 as a high risk order, medium risk order, or low risk order. In an embodiment, the order risk evaluator 140 is implemented as code that can be executed by a processor such as processor 119 in the server 118. In other embodiments, the order risk evaluator 140 may be implemented as a new code within an eFalcon module (or other fraud analysis module) 155 and executed by the eFalcon module 155 as a filter set to categorize an order 110 as a high risk order, medium risk order, or low risk order. Therefore, the EFALCON module is just one example of the module 155. The eFalcon module 155 is typically an e-commerce fraud detection product from, for example, FAIR, ISSAC AND COMPANY, San Rafael, Calif., and compares the transaction to general fraud patterns. In other embodiments, the order risk evaluator 140 may be independent from the eFalcon module 155 and the eFalcon module 155 may be omitted from the transaction processing module 125. In other embodiments, the order risk evaluator 140 can be implemented as a web tool that can be accessed by use of a web interface. In other embodiments, the order risk evaluator 140 can be implemented to function with a database, such as a database available from ORACLE CORPORATION of Redwood Shores, Calif. An example of the order risk evaluator 140 is disclosed in, for example, U.S. patent application Ser. No. ______ by Richard York, entitled “ORDER RISK DETERMINATION”, which is hereby fully incorporated herein by reference. In other embodiments, the order risk evaluator 140 may be omitted in the transaction processing module 125, and the incoming order 110 may be manually classified as a high risk order, medium risk order, or low risk order based upon one or more criteria. For example, an incoming order 110 may be categorized as a high risk order if the order price amount exceeds a maximum threshold price amount (e.g., $500), may be categorized as a medium risk order if the order price amount is within a defined price range (e.g., between $100 and $500), and may be categorized as a low risk order if the order price amount is below a minimum threshold price amount (e.g., $100). Therefore, if the order 110 has a price amount of, for example, $510, then the order 110 is classified as a high risk order. If the order 110 has a price amount of, for example, $200, then the order 110 is classified as a medium risk order. If the order 110 has a price amount of, for example, $80, then the order 110 is classified as a low risk order.

As another example, an incoming order 110 may be categorized as a high risk order if the order quantity amount exceeds a maximum threshold quantity amount (e.g., 10 items), may be categorized as a medium risk order if the order quantity amount is within a defined range (e.g., between 5 items to 10 items), and may be categorized as a low risk order if the order quantity amount is below a minimum threshold amount (e.g., 5 items). Other criteria or a combination of criteria can be used to classify an order as a high risk order, medium risk order, or low risk order.

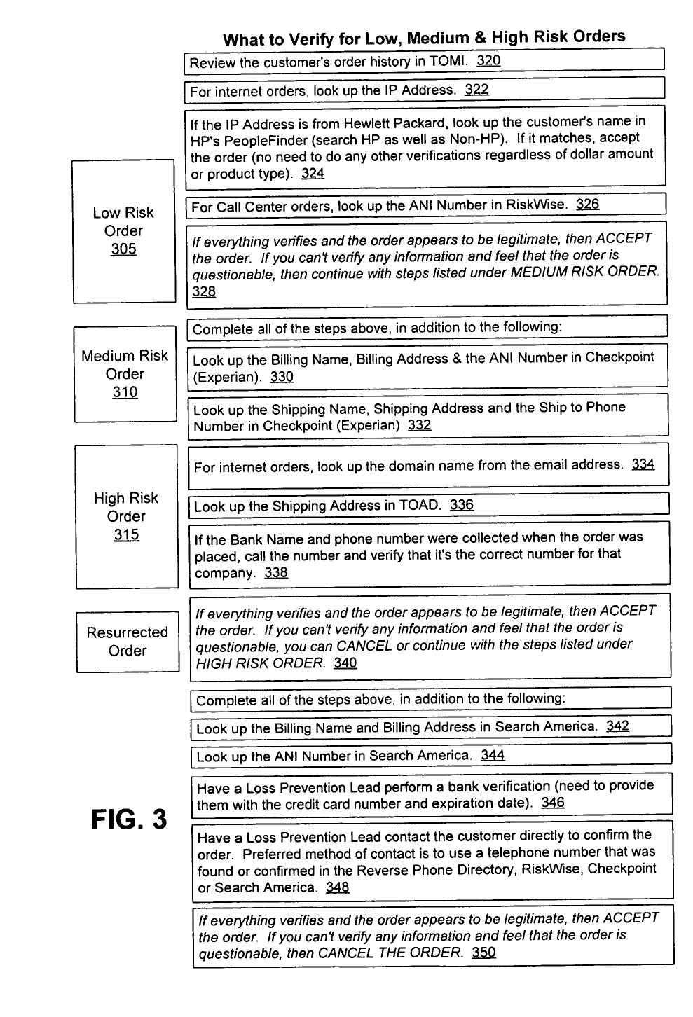

In an embodiment of the invention, an incoming order verification module 150 then provides a set of information to verify based upon the risk factor (i.e., low risk, medium risk, or high risk) associated with the incoming order 110, and verifies an appropriate set of information to determine if the order 110 is related to a potential fraudulent activity. This verification method is generally illustrated in FIG. 3. In other embodiments of the invention, the order risk evaluator 140 and initial order review module 145 may be omitted in the transaction processing module 125.

The modules in the transaction processing module 125 described above are typically implemented in software code.

FIG. 2A is a high-level flowchart illustrating a method 180 for an initial order review workflow that may be used in an embodiment of the invention. Additional details of the method 180 are shown in method 200 in FIG. 2B. It is noted that other suitable methods for an initial order review workflow may be used in an embodiment of the invention. Therefore, the example method 180 in FIG. 2A is not intended to limit the scope of embodiments of the invention. Particular steps in the method 180 may be executed by the initial order review workflow module 145 of FIG. 1, or the initial order review workflow module 145 is used to permit the analyst 131 to perform particular steps in the method 180. An incoming order 110 is received (182) from a customer. Fraud shield rules are then applied (184) to the order 110 and customer 105 information to determine if the order 110 and customer 105 information have information that matches a negative file. In one embodiment, if a fraud shield rule fires, then the order 110 is rejected or not approved.

The fraud analyst 131 can request (186) preauthorization from an issuing bank for funds to pay for the order 110. In one embodiment, if preauthorization is declined, then the order 110 is rejected.

The fraud analyst 131 can perform (188) an address verification system (AVS) check on the customer 105 who transmitted the order 110. In an embodiment, if the information provided by the customer 105 does not match the information in an issuing bank from a result of the AVS check or if the customer 105 is using a foreign credit card, then the order 110 is rejected. In another embodiment, then the analyst 131 can perform further analysis for fraud on the order 110 instead of automatically rejecting the order 110.

The fraud analyst 131 can check (190) the card verification number (CVN) of a credit card of the customer 105. In an embodiment, if there is a match in the CVN code, then the analyst 131 can approve the order 110. In an embodiment, if there is not a match in the CVN code, then the analyst 131 can perform further analysis for potential fraud on the order 110.

The initial order review module 145 can apply (192) a fraud analysis rule to the order 110 to determine if an automatic-reject rule fires, if an outsort rule fires, if a positive rule fires, or if none of the automatic-reject rule, the outsort rule, and the positive rule fires. If an automatic-reject rule fires, then the order 110 is rejected.

On the other hand, the order 110 is accepted (194) if none of the automatic-reject rule and the outsort rule fires.

Alternatively, the order 110 is also accepted (196) if a positive rule fires.

If an outsort rule fires, then a determination is made (198) on a level of risk of fraud for the order 110. In one embodiment, a determination is made if the order 110 should be classified as a high risk order, medium risk order, or low risk order, in order to classify a level of risk for fraud for the order.

FIG. 2B is a flowchart illustrating additional details of a method 200 for an initial order review workflow that may be used in an embodiment of the invention. It is noted that other suitable methods for an initial order review workflow may be used in an embodiment of the invention. Therefore, the example method 200 in FIG. 2B is not intended to limit the scope of embodiments of the invention. Particular steps in the method 200 may be executed by the initial order review workflow module 145 of FIG. 1, or the initial order review workflow module 145 is used to permit the analyst 131 to perform particular steps in the method 200.

An incoming order 110 is determined (202) as an order received via a call center 120 or is determined (204) as an order received via a web site 115. Fraud shield rules are then applied (206) to the incoming order 110. One product that implements the fraud shield rules is of the type available from, for example, CLEARCOMMERCE CORPORATION, Austin, Tex. A fraud shield rule product stores negative files. A negative file has, for example, a particular address and/or phone number associated with a past known fraudulent order. A check (207) is made to determine if a rule in the fraud shield rules fires (triggers). A fraud shield rule will fire if the incoming order has information matching information in the negative files. If a fraud rule fires, then the order is automatically rejected (208). If a fraud shield rule does not fire, then the method 200 proceeds (209) to block (210).

Pre-authorization will be requested (210) from an issuing bank (participating bank) for funds to pay for the order 110. If pre-authorization is declined (211), then the order is automatically rejected (212). Pre-authorization may be declined (211) if, for example, the customer for the incoming order does not have enough funds in the issuing bank to pay for the incoming order. On the other hand, if the pre-authorization is received (213), then the method 200 proceeds (214) to block (215).

An address verification system (AVS) check is then performed (215). The AVS code is a feature to verify the cardholder's address and zip code at the time of the transaction, and to verify if the information that the cardholder (customer 105) has entered matches the information that is stored at the issuing bank. If an “N” code is received (216), then the order is automatically rejected (217). If the AVS code is equal to “N”, which means that there was no match between the cardholder's address and the information stored at the issuing bank, then the order will be classified as a high risk order. As a result, the order will be automatically rejected (217).

If, after performing (215) the AVS check, a “G” code is received (218), then the order is automatically rejected (219). If the AVS code is equal to “G”, which means that the customer 105 is using a foreign credit card, then the order will be classified as a high risk order. As a result, the order will be automatically rejected (219).

In another embodiment, the order will not be automatically rejected if an N code or G code is received after performing (215) the AVS check. In this alternative embodiment, the analyst can perform further analysis for potential fraud, instead of automatically rejecting the order. Thus, blocks (216), (217), (218), and (219) may be omitted in other embodiments of the invention.

If, after performing (215) the AVS check, another code (except “N” or “G) is received (220), then the method 200 proceeds (221) to block (222).

The card verification number (CVN) authorization code is checked (222). Most credit cards now include a 3 or 4 digit card verification number, which is not part of the regular credit card number. Telephone and Internet merchants can use these numbers to verify that the card is in fact in the customer's hand as the CVN numbers are not embedded in the magnetic stripe of the card. A CVN authorization code equal to “N” means that there is no match found for the CVN code. In an embodiment, if there is a match in the CVN code, then the analyst 131 can approve the order 110. A CVN authorization code equal to “S” means that a verification system being used by the analyst is unable to verify the CVN code. The CVN code is received (223) after performing (222) the CVN check. In one embodiment, an order is not automatically cancelled in response to particular CVN codes such as code “N” or code “S”. Instead, in this embodiment, the CVN code is available for an analyst to consider when analyzing the incoming order for potential fraud.

A fraud analysis by use of the eFalcon product 155 (or other similar fraud analysis tool) is then performed (224), in order to determine if an automatic-reject rule fires, an outsort rule fires, or a positive rule fires. It is noted that this function by the eFalcon product 155 of performing a fraud analysis may be performed by the initial order review module 145; therefore, the eFalcon product 155 may be omitted in this alternative embodiment. If one of the automatic-reject rules fires, then the incoming order 110 is automatically rejected (226). An automatic-reject rule identifies a likelihood of fraudulent activity with the incoming order 110.

On the other hand, if a “positive rule” fires (227) after performing the analysis under the eFalcon product 155, then the order 110 is automatically accepted (228). A positive rule permits an order 110 to be automatically accepted, since the event associated with the triggering of the positive rule makes it very unlikely that a fraudulent activity is associated with the incoming order 110. For example, a positive rule is triggered if the incoming order 110 is made from an internal website of the vendor (e.g., an order 110 for a Hewlett-Packard product is made from a Hewlett-Packard employee internal website). As another example, if the credit card number (that is used for the incoming order 110) belongs to a customer satisfaction group (or other pre-selected group) of the vendor, then a positive rule is triggered, where the customer satisfaction group orders replacement products for the vendor. Activities from these pre-selected groups of the vendor are unlikely related to fraudulent activities. Other events can be associated with the firing of a positive rule(s).

On the other hand, if an outsort rule(s) fires (230), then the method 200 proceeds (231) to the risk filter analysis block (232). The risk filter analysis block (typically implemented by the order risk evaluator 140 in FIG. 1) analyzes and assigns the level of risk for fraud for an incoming order 110. An order 110 can be selected for outsort by use of any suitable methods, such as, for example, outsorting all incoming orders 110, outsorting randomly picked incoming orders 110, outsorting an incoming order 110 based upon one or more criteria that can be predefined by the user of the transaction processing module 125, and/or outsorting an incoming order 110 based upon other suitable methods.

Alternatively, if a positive rule or an outsort rule(s) or an automatic-reject rule(s) fails (229) to fire for the incoming order, then the order is automatically accepted or approved (228). In other words, in block (229), the order has gone through without any rules firing.

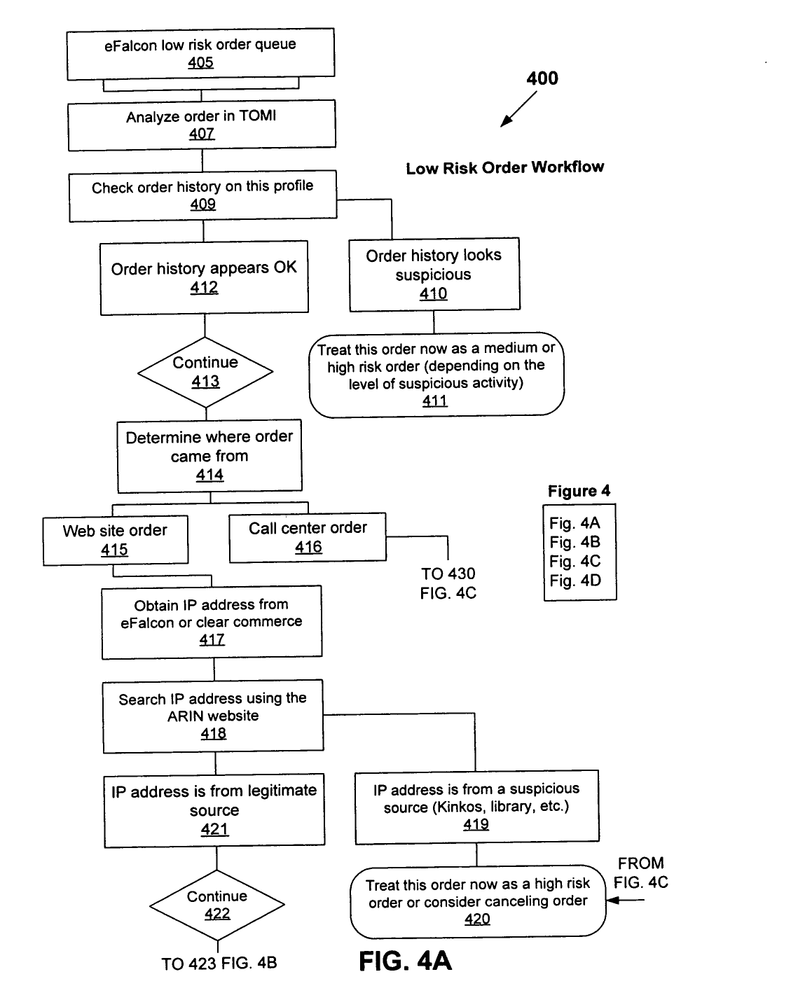

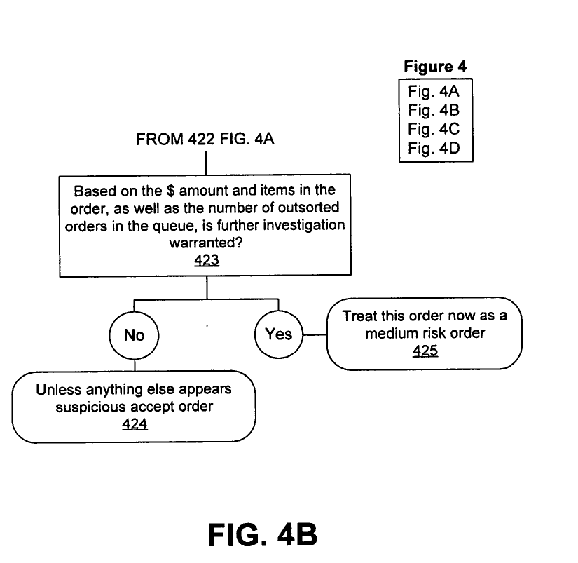

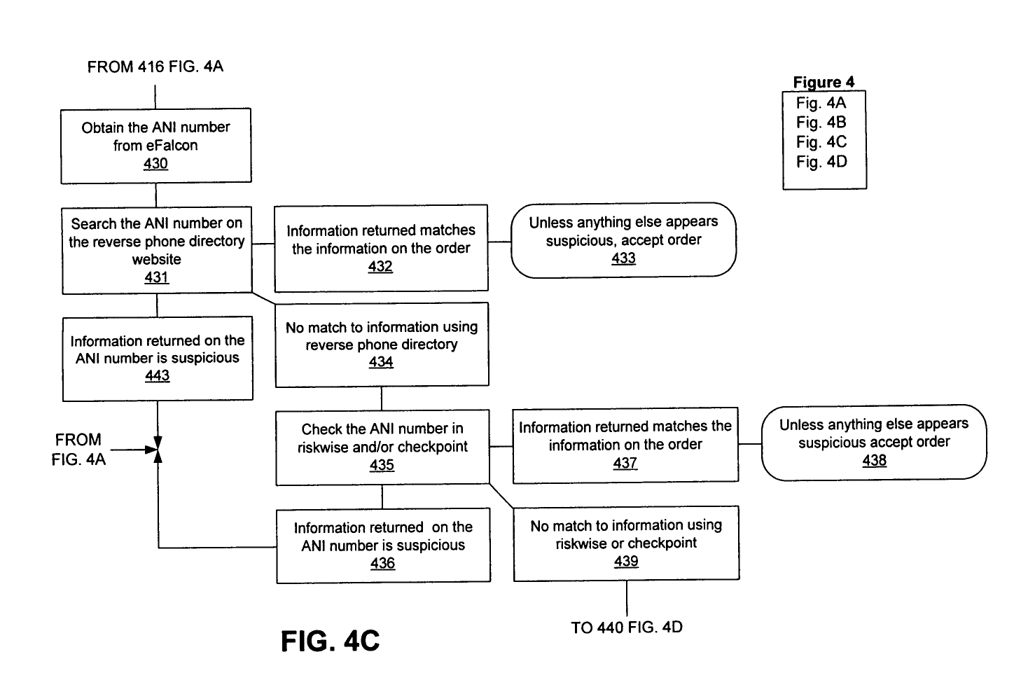

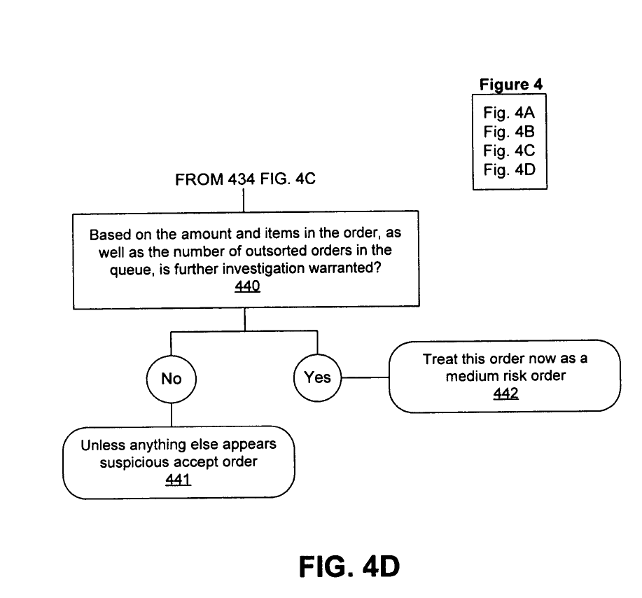

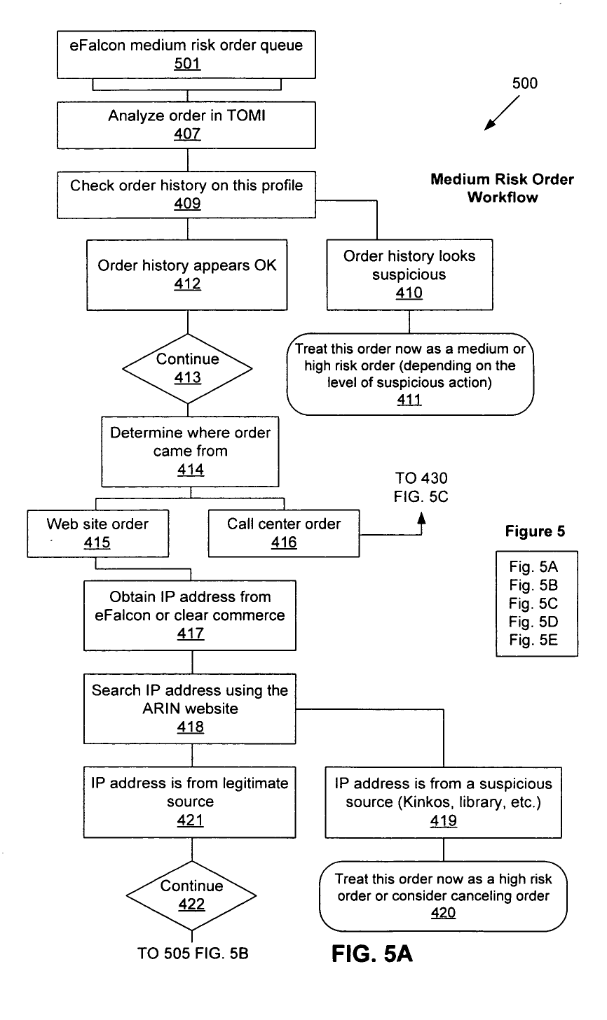

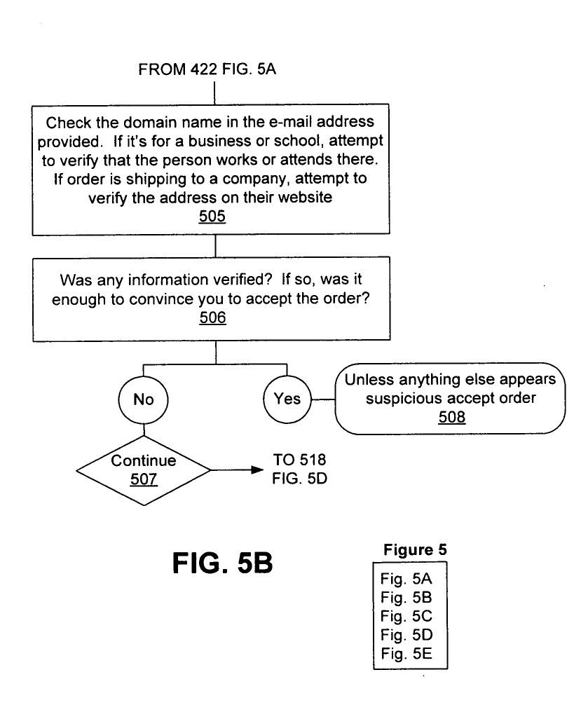

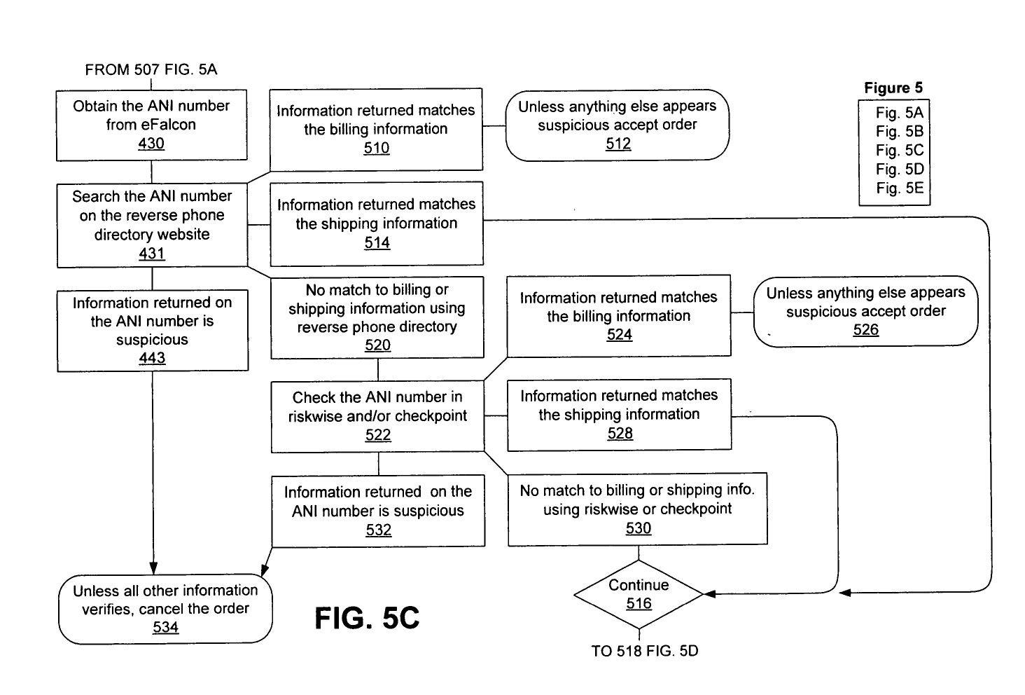

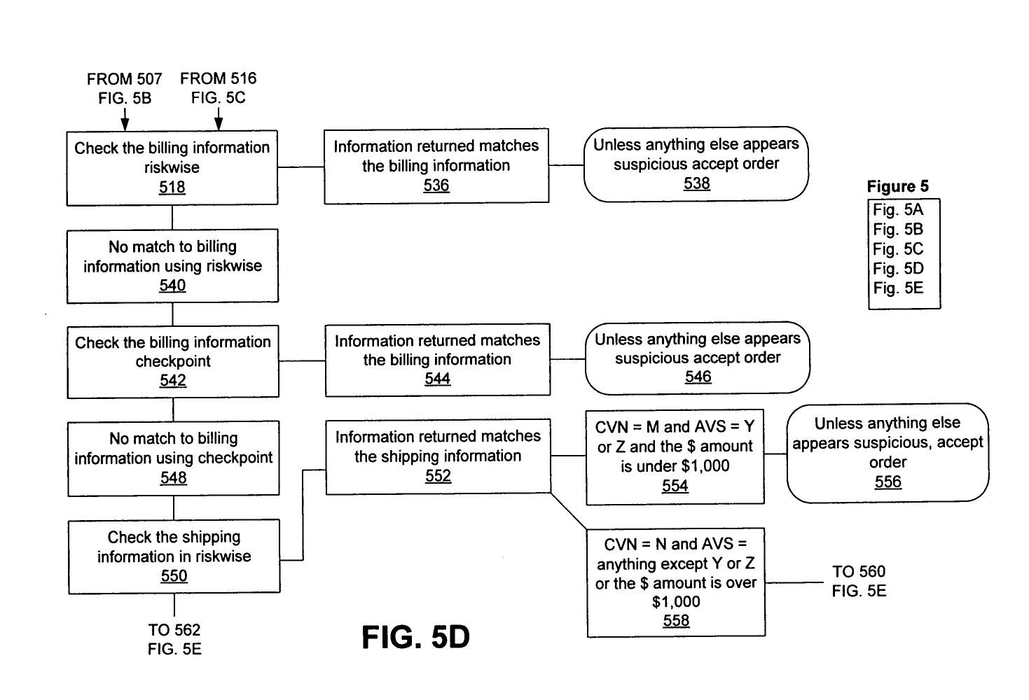

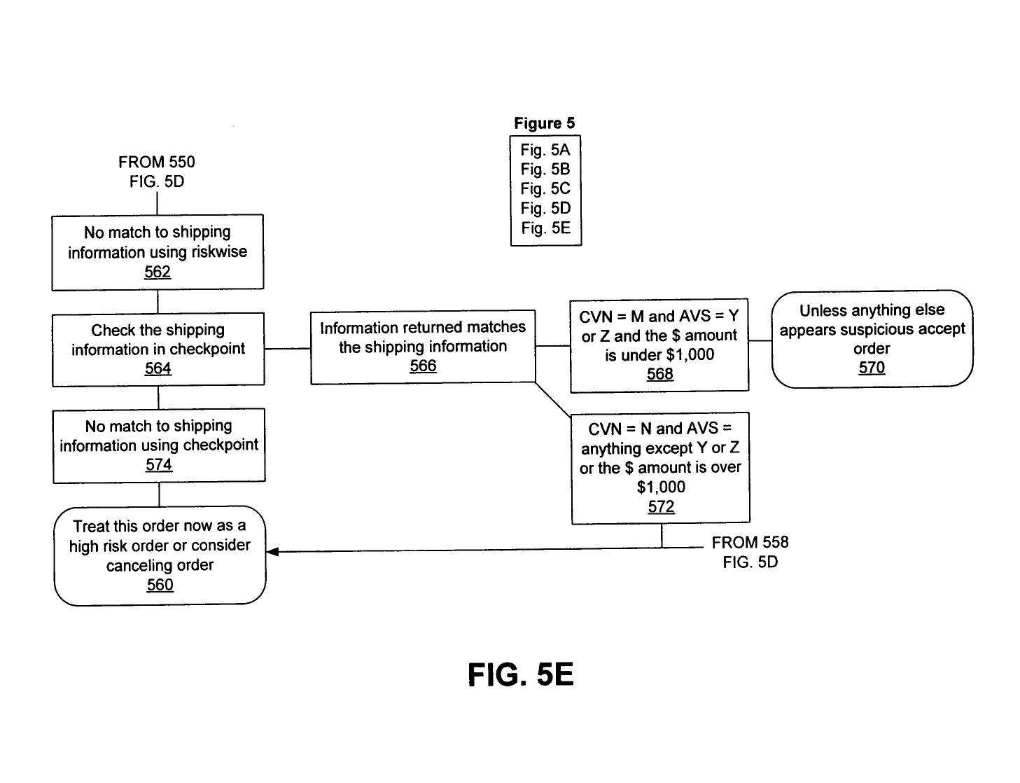

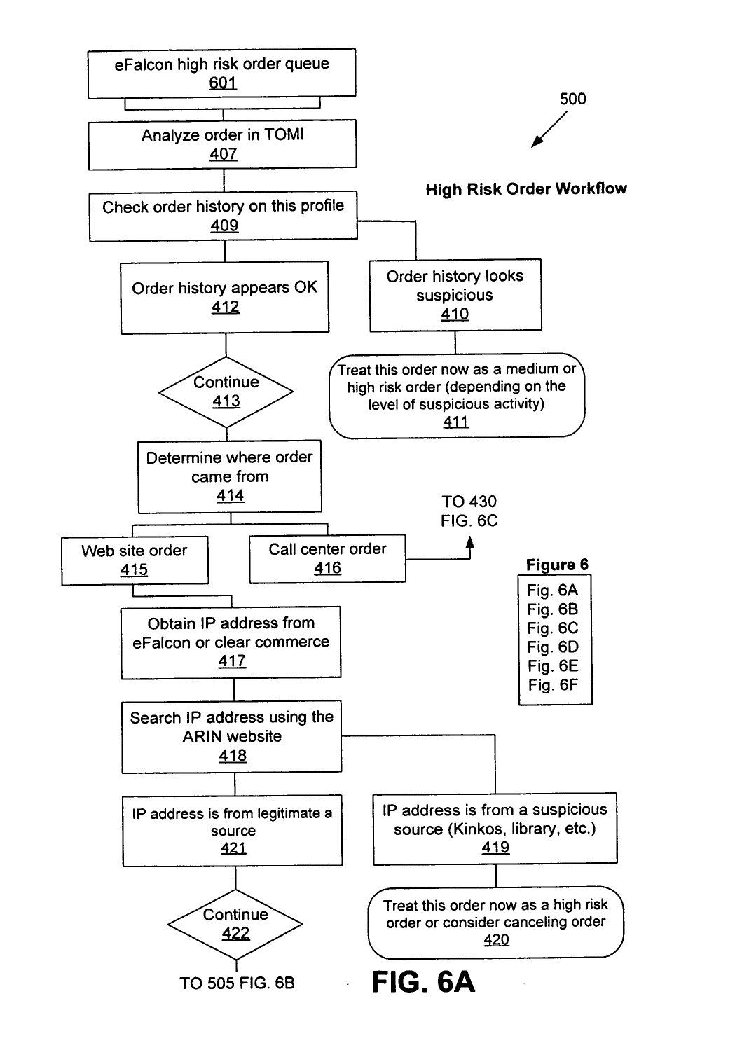

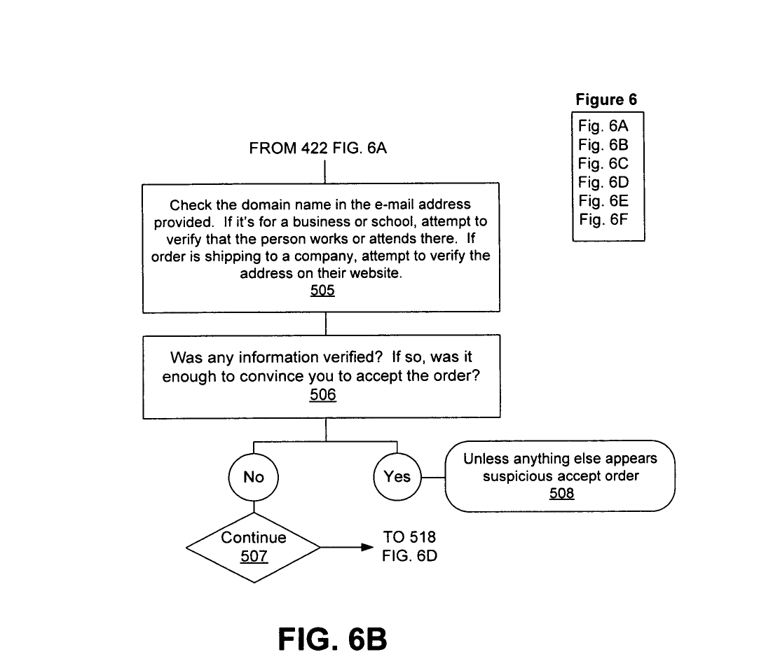

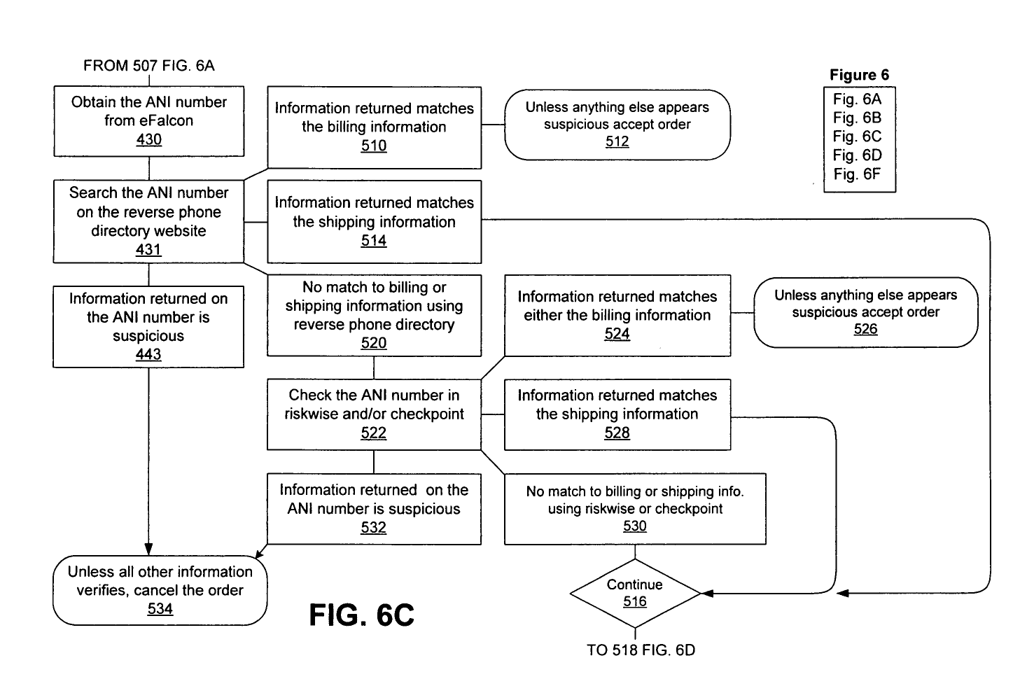

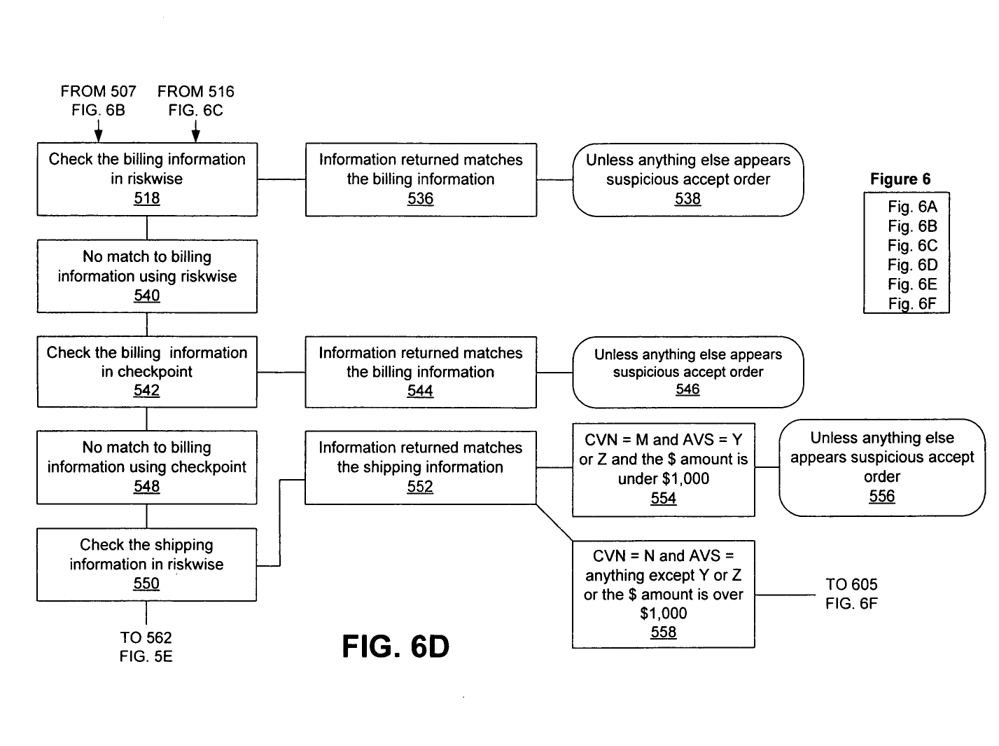

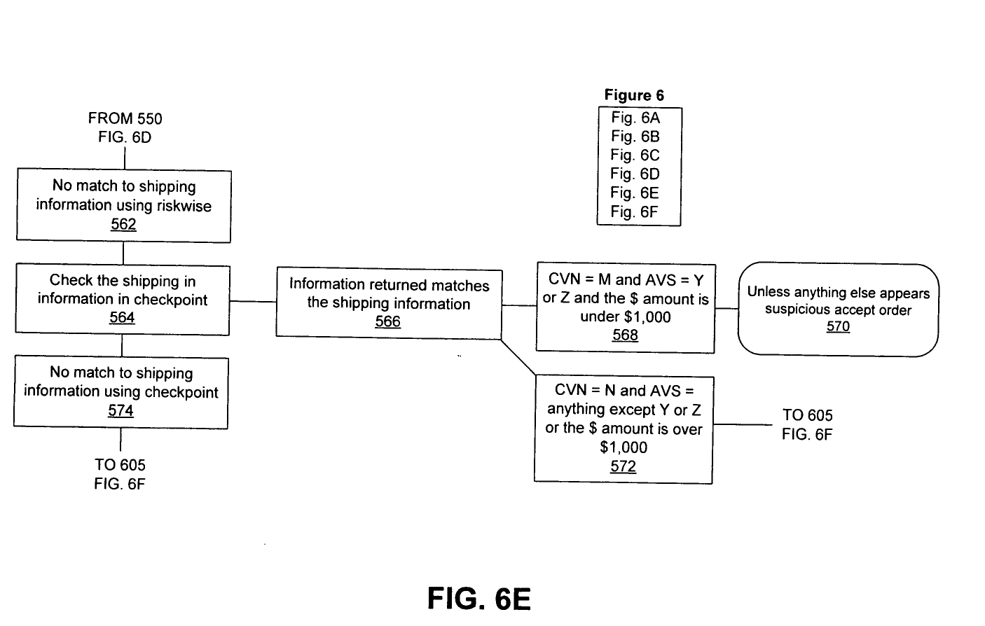

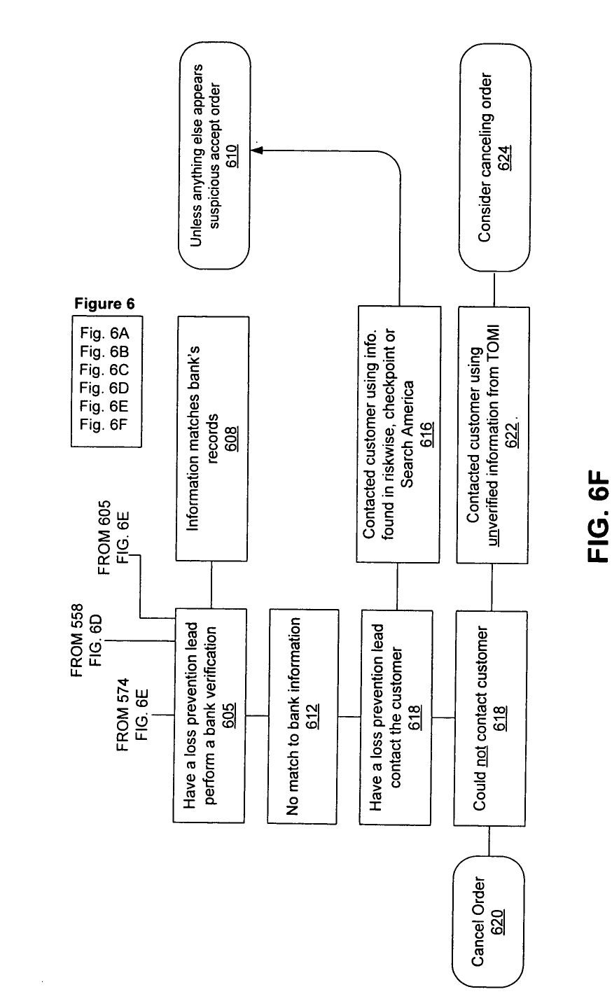

If, in step (230) an outsort rule(s) fires for the order 110, the risk factor to assign to the incoming order 110 is then determined (232), by use of a risk filter as described in, for example, the above-referenced patent application entitled “ORDER RISK DETERMINATION” by Richard York. As previously noted above, other methods may be used to determine the particular risk factor that will be assigned to the order 110. If the incoming order 110 is categorized as a low risk order (i.e., placed in a low risk queue (233) in FIG. 1), then the order is analyzed (234) for potential fraud by use of the low risk order workflow as described below with reference to FIG. 3 and/or FIG. 4. If the incoming order is categorized as a medium risk order (i.e., placed in a medium risk queue (235)), then the order is analyzed (236) for potential fraud by use of the medium risk order workflow as described below with reference to FIG. 3 and/or FIG. 5. If the incoming order is categorized as a high risk order (i.e., placed in a high risk queue (237)), then the order is analyzed (238) for potential fraud by use of the high risk order workflow as described below with reference to FIG. 3 and/or FIG. 6.

FIG. 3 is a flowchart illustrating which information to verify for a low risk order, a medium risk order, and a high risk order, in accordance with an embodiment of the invention. An incoming order may be assigned a risk factor of “low risk” 305 (i.e., placed in the low risk queue (233) of FIG. 2), “medium risk” 310 (i.e., placed in the medium risk queue (235)), or “high risk” 315 (i.e., placed in the high risk queue (237)).

If an incoming order has been assigned the risk factor of “low risk” 305, then the following analysis is performed. The customer's order history is reviewed (320) in an internal website of the vendor (e.g., the TOMI internal website of Hewlett-Packard Company, or another suitable type of internal website). For example, the internal website can indicate if the customer is a previous customer. For orders made via the Internet, the Internet Protocol (IP) address is reviewed (322). If the IP address is assigned to the vendor (e.g., Hewlett-Packard), then the method checks (324) the customer's name by looking up the name by use of a known search tool (e.g., PEOPLEFINDER website <www.peoplefinder.com> in the Internet or an employee search tool in the company). Preferably, the customer's name is searched in the employee names of the vendor and the non-employee names. If the customer's name matches a stored name in the vendor's employee list, then the order is accepted. In an embodiment, if the customer's name matches a name in the vendor's employee list, then the order is accepted without performing additional verification regardless of the dollar amount of the order or the product type that is being ordered.

For orders made via a call center, the auto-number identification (ANI) is checked (326) via a reverse phone directory website (e.g., RISKWISE <www.riskwise.com>, the reverse phone directory website <http://website.tc/reverse-phone-search.htm>, or other suitable ANI verification tools, services, or websites).

In block (328), the order is accepted if the checks made in blocks (320), (322), (324) and/or (326) make the analyst conclude that the order is not fraudulent. If the analyst 131 can not verify at least one of the information to be checked in blocks (320), (322), (324) and/or (326), then the analyst can reclassify the order as a medium risk order 310 and proceed with further analysis shown in blocks (330) to (340). Alternatively, if the analyst 131 concludes that the order is from a suspicious source (e.g., the order originated from a publicly accessible IP address such as an IP address assigned to a computer in a KINKOS' facility or in a public library), then the analyst 131 can automatically cancel/reject the order 110 and advantageously avoid devoting additional time/resource to analyze the order 110, since the suspicious source makes fraud likely in the order 110.

It is noted that block (328) gives an analyst 131 further discretion on whether to automatically reject an order 110 or to further analyze the order 110 as a medium risk order 310. For example, if the number of orders 110 to be evaluated in the low risk queue (233), medium risk queue (235), and/or high risk queue (237) is few, then the analyst 131 can spend more time to evaluate a particular order 110. Otherwise, block (328) gives an analyst 131 discretion to cancel/reject the order 110 if the analyst 131 can not verify at least one of the information in blocks (320), (322), (324), and (326). The block (328) advantageously permits the analyst 131 to cancel an order 110 that may be suspicious or to further investigate a potentially legitimate order 110. Thus, block (328) may permit the efficient processing of incoming orders 110 and may prevent the waste of time and resource in the processing of potentially fraudulent orders.

The block (320) through block (328) represent a fraud investigation process that requires a lower amount of resource and time as required for an order with a low likelihood of fraud. In contrast, the a fraud investigation process as performed in block (330 through block (340) will require more resource and time.

If an order has been assigned the risk factor of “medium risk” 310, then the following analysis is performed as described below. It is noted that a low risk order 305 can be reclassified by an analyst as a medium risk order 310 if the analyst decides to perform further examination on an incoming order 110. As a result, the analysis in blocks (330) to (340) will be performed for the reclassified order 310.

For a medium risk order 310, the analysis in previous blocks (320) to (326) is performed. The method then proceeds to block (330), where the analyst 131 will check the billing information (billing name, billing address, and ANI number) by use of a pay service such as, for example, the CHECKPOINT service provided by EXPERIAN, Costa Mesa, Calif. <www.experian.com>, or other suitable customer verification tools or services. The CHECKPOINT service insures the accuracy of customer information, and uses a powerful database of about 150 million consumers and about 25 million businesses to instantly verify customer data. If the billing information provided by the customer 105 matches the billing information provided by the pay service, then the analyst 131 can accept the order 110.

If the billing information provided by the customer 105 does not match the billing information provided by the pay service, then the analyst 131 can check (332) the shipping information (e.g., shipping name, shipping address, and phone number for the shipping) in a pay service such as CHECKPOINT. If, for example, the shipping address is a suspicious location (e.g., a warehouse, liquor store, or another suspicious location that is not the residence of the customer 105), then the analyst 131 can automatically reject the order 110.

For orders made via the Internet, the domain name of the e-mail address of the customer 105 can be checked (334) to determine potential fraud. The analyst can then accept or reject the order 110. For example, if the domain name of the customer's 105 e-mail address is the same as the vendor's domain name, then the analyst 131 can accept the order.

A shipping address can also be verified (336) in TOAD or other address search tools or address search services that can verify information about addresses.

If the name and phone number of the issuing bank were collected when the order 110 was placed, then the analyst 131 can call (338) the phone number to verify if the phone number is for the issuing bank. The analyst 131 can then accept or reject the order 110.

In block (340), if the information obtained in blocks (330) to (338) are verified and appear to be legitimate, then the analyst 131 can accept the order 110. If the analyst 131 can not verify at least one of the information to be checked in blocks (330), (332), (334), (336), and/or (338), then the analyst 131 can cancel (reject) the order 110, or the analyst 131 can reclassify the order 110 as a high risk order 315 and proceed with further analysis shown in blocks (342) to (350). The block (340) advantageously permits the analyst to cancel an order that may be suspicious or to further investigate a potentially legitimate order.

The block (330) through block (340) represent a fraud investigation process that requires an increased amount of resource and time, as required for an order 110 with an increased likelihood of fraud.

If an order has been assigned the risk factor of “high risk” 315, then the following analysis is performed as described below. It is noted that a medium risk order 310 can be reclassified by an analyst 131 as a high risk order 315 if the analyst 131 decides to perform further examination on an incoming order 110. As a result, the analysis in blocks (342) to (350) will be performed for the reclassified order.

For a high risk order 315, the analysis in previous blocks (320) to (338) is performed where the analyst 131 will check the billing information (billing name and billing address) by use of a more comprehensive pay service such, for example, SEARCH AMERICA <www.searchamerica.com>. The analyst 131 then checks (344) the ANI number in the comprehensive pay service such, for example, as SEARCH AMERICA. A designated loss prevention team member (e.g., a loss prevention lead personnel of the vendor) can perform (346) verification by contacting a bank, or the fraud analyst 131 can contact the bank for verification. Typically, the customer's credit card number and expiration date is provided to the designated loss prevention team member for verification. The designated loss prevention team member then contacts (348) the customer 105 directly to confirm the order 110. In a preferred embodiment, the designated loss prevention team member calls the telephone number that was found or confirmed in, for example, the reverse phone directory search, RISKWISE, CHECKPOINT, or SEARCH AMERICA.

If all information checked in blocks (342) to (348) are verified to be correct and the order appears to be non-fraudulent, then the order is accepted (350). If at least one of the information checked in blocks (342) to (348) and the order appears to be questionable, the order is cancelled in block (350).

The block (342) through block (350) represent a fraud investigation process that requires a higher amount of resource and time, as required for an order with a high likelihood of fraud.

FIG. 4 is a flowchart illustrating additional details for a method 400 for a low risk order workflow, in accordance with an embodiment of the invention. If an order 110 is assigned a risk factor of low risk (305), then the order 110 is placed (405) in the low risk order queue 233 (see FIG. 2B). The customer's order history is then analyzed (407) in an internal website. In particular, the order history of the customer is checked and analyzed (409). Based on the analysis of the customer's order history, if the order looks (410) suspicious for potential fraud, then the order is treated or reclassified (411) as a medium risk order 310 or high risk order 315, depending on the level of suspicious activity. In another embodiment, the analyst 131 can cancel the order 110, instead of reclassifying (411) the order 110.

If the order history appears (412) legitimate, then the method 400 proceeds (413) to block (414).

A determination is made (414) on where the order 110 originated. If the order 110 came (415) via a website 115, then various actions are followed as described below. If the order 110 came (416) via a call center 120, then other various actions are followed as described below.

If an order came (415) via a website 115, then the IP address of the source of the order 110 is obtained (417) from particular products from various vendors such as, for example, the FAIR, ISSAC AND COMPANY or CLEARCOMMERCE CORPORATION. The IP address is then searched (418) by use of the ARIN (American Registry For Internet Numbers) website <http://www.arin.net/> or other similar services that list a registry of Internet addresses. The ARIN service manages the Internet numbering resources for North America, and a portion of the Caribbean and sub-equatorial Africa. A full list of countries in the ARIN region can be found in the ARIN website.

Based upon the search result of the registry of Internet addresses as performed in step (418), if the IP address is from a suspicious source (419), such as a computer from a KINKO'S INCORPORATED facility, other document preparation or computer access facility, library, and/or other publicly accessible facilities or other suspicious source, then the order 110 is treated (420) as a high risk order 315 or the order should be cancelled by the analyst 131.

If the IP address is from a legitimate or non-suspicious source (421), then the method 400 proceeds (422) to block (423).

A determination is made (423) if further investigation is warranted for the order. Among factors to consider includes, for example, the dollar amount of the order, the item(s) in the order, and/or the number of outsorted order in the queue. If further investigation is not warranted and there are no other factors that appear suspicious in the order, then the order is accepted (424). On the other hand, if further investigation is warranted, then the order is now treated (425) as a medium risk order 310 and further analysis of the order is performed based upon the analysis for medium risk orders 310 as shown in, for example FIG. 3 or FIG. 5.

If the order came (416) from a call center, then the ANI number is obtained (430) from, for example, the eFalcon product 155. The ANI number is searched (431) on a reverse phone directory website or other similar search tools. If the information returned from the reverse phone directory search matches (432) the information on the order and there are no other factors that appear suspicious in the order, then the order is accepted (433). On the other hand, if the search does not return (434) information that matches the information on the order, then the ANI number is checked (435) in RISKWISE and/or CHECKPOINT. If the information returned (436) on the ANI number check is suspicious, then the order is treated (420) as a high risk order 315 or the order should be cancelled by the analyst 131.

If the information returned on the ANI number check matches (437) the information on the order and there are no other factors that appear suspicious in the order, then the order is accepted (438).

If the information returned on the ANI number check returns (439) no information that matches the information on the order, then a determination is made (440) if further investigation is warranted for the order. Among factors to consider includes, for example, the dollar amount of the order, the item(s) in the order, and/or the number of outsorted order in the queue. If further investigation is not warranted and there are no other factors that appear suspicious in the order, then the order is accepted (441). On the other hand, if further investigation is warranted, then the order is now treated (442) as a medium risk order 310 and further analysis of the order is performed based upon the analysis for medium risk orders 310 as shown in FIG. 3 or FIG. 5.

If the information returned from the ANI number search (431) in the reverse phone directory search is suspicious (443), then the order is treated (420) as a high risk order 315 or the order should be cancelled by the analyst 131.

FIG. 5 is a flowchart illustrating a method 500 for a medium risk order workflow, in accordance with an embodiment of the invention. If an order 110 is assigned a risk factor of medium risk 310, then the order 110 is placed (501) in the medium risk order queue 235 (see FIG. 2B).

The functions in block (407) to block (422) and blocks (430), (431) and (443), as previously described in FIG. 4, are repeated in the method 500. If the order came (416) from a call center, then the method 500 proceeds to block (430) as described below. If the order came (415) from a web site, then the order proceeds to blocks (417) to (422) as similarly described above. If the IP address is from a legitimate source (block 421), the method 500 proceeds (422) to block (505).

A check is performed (505) on the domain name in the e-mail address provided by the customer 105. If the domain name is for a business or school or other legitimate entity, then the analyst 131 can attempt to verify that the customer 105 works at the business, attends the school, or is otherwise associated with the legitimate entity. If the order 110 is shipping to a company address, then the analyst 131 can attempt to verify the company address on the company website.

A determination is made if any of the information was verified. If at least some of the information was verified, then the analyst 131 can determine (506) if the verified information was enough to convince the analyst 131 to accept the order 110. If the verified information was not enough to convince the analyst 131 to accept the order 110, then the method 500 proceeds (507) to block (518) as described below. If the verified information was enough to convince the analyst 131 to accept the order 110, then the analyst 131 can accept (508) the order 110 unless anything else about the order 110 appears to be suspicious.

If the order 110 is received via a call center (block 416), then the ANI number is obtained (430) by use of the eFalcon product 155 or other similar product. The ANI number is searched (431) on a reverse phone directory website or other similar search tools. If the information returned from the reverse phone directory search matches (510) the billing information, then the order 110 is accepted (512) unless anything else about the order appears as suspicious. If the information returned from the reverse phone directory search matches (514) the shipping information, then the method 500 proceeds (516) to block (518) as discussed below. If the information returned from the reverse phone directory search does not match (520) the shipping information or billing information, then a check (522) is made on the ANI number in RISKWISE or CHECKPOINT.

If the information returned from the ANI number check matches (524) the billing information, then the order 110 is accepted (526) unless anything else about the order 110 appears as suspicious. If the information returned from the ANI number check matches (528) the shipping information, then the method 500 proceeds (516) to block (518) as discussed below. If the information returned from the ANI number check does not match (530) the billing information or the shipping information by use of RISKWISE or CHECKPOINT, then the method 500 proceeds (516) to block (518) as discussed below. If the information returned from the ANI number check is suspicious (block 532), then the order 110 is cancelled (534) unless all other information about the customer is verified. It is noted that if the information returned (443) from the ANI number search is suspicious, then the order 110 is also cancelled (534) unless all other information about the customer is verified.

In block (518), a check is performed on the billing information by use of RISKWISE. If the information returned from the billing information check matches (536) the customer's provided billing information, then the order 110 is accepted (538) unless anything else about the order 110 appears as suspicious.

If the information returned from the billing information check does not match (540) the customer's provided billing information by use of RISKWISE, then the billing information is checked (542) by use of CHECKPOINT. If the billing information check matches (542) the customer's provided billing information, then the order 110 is accepted (546) unless anything else about the order appears as suspicious.

If the information returned from the billing information check does not match (548) the customer's provided billing information by use of CHECKPOINT, then the shipping information is checked (550) by use of RISKWISE. If the shipping information check by use of RISKWISE matches (552) the customer's provided shipping information, then the CVN code, the AVS code, and the dollar amount of the order are checked (554). If the CVN code equals “M”, the AVS code equals “Y” or “Z”, and the dollar amount of the order is under $1,000, as shown in block (554), then the order is accepted (556) unless anything else about the order appears as suspicious. The code M result in the CVN check and the code Y and Z results in the AVS check indicates acceptable matching results. The dollar amount in block (554) may be varied to other values.

If the CVN code equals “N” and the AVS code does not equal “Y” or “Z”, or if the dollar amount of the order is over $1,000, as shown in block (558), then the order is treated as a high risk order or the analyst can consider in canceling the order (block 560). The dollar amount in block (558) may be varied to other values.

If the shipping information check by use of RISKWISE does not match (562) the customer's provided shipping information, then the shipping information is checked (564) by use of CHECKPOINT. If the shipping information check by use of CHECKPOINT matches (566) the customer's provided shipping information, then the CVN code, the AVS code, and the dollar amount of the order are checked in block (568). In block (568), if the CVN code is equal to “M” and the AVS code is equal to “Y” or “Z”, or the dollar amount of the order is under $1,000, then the order is accepted (570) unless anything else about the order appears as suspicious. On the other hand, in block (568), if the CVN code is equal to “N” and the AVS code does not equal to “Y” or “Z”, or the dollar amount of the order is over $1,000, then the order is treated as a high risk order or the analyst can consider in canceling the order (block 560). In blocks (568) and (572), the $1,000 amount may be varied.

If the shipping information check by use of CHECKPOINT does not match (574) the customer's provided shipping information, then the order 110 is now treated as a high risk order or the analyst 131 can consider in canceling the order 110 as shown in block (560).

FIG. 6 is a flowchart illustrating a method 600 for a high risk order workflow, in accordance with an embodiment of the invention. If an order 110 is assigned a risk factor of high risk 315, then the order 110 is placed (601) in the high risk order queue 237 (see FIG. 2B).

The functions in block (407) to block (422), block (430), block (431) and block (443), and block (505) to block (574), as previously described in FIG. 4 and/or FIG. 5, are repeated in the method 600.

If the CVN code equals “N” and the AVS code does not equal “Y” or “Z”, or if the dollar amount of the order is over $1,000, as shown in block (558), then the method 600 proceeds to block (605) as discussed below.

If the shipping information check by use of CHECKPOINT does not match (574) the customer's provided shipping information, then the method 600 proceeds to block (605) as discussed below.

A designated loss prevention team member (e.g., a loss prevention lead or the analyst 131) for the vendor will perform (605) a bank verification of the customer 105. If the customer's information matches (608) the bank's records, then the order 110 is accepted (610) unless anything else about the order 110 appears as suspicious.

If the customer's information does not match (612) the bank's records, then the designated loss prevention team member may contact (614) the customer 105. If the customer 105 is contacted (616) by using information found in RISKWISE, CHECKPOINT, or SEARCH AMERICA search tools, then the order 110 is accepted (610) unless anything else about the order 110 appears as suspicious.

If the designated loss prevention team member could not contact (618) the customer 105, then the order 110 is canceled (620). If the designated loss prevention team member contacted (622) the customer 105 by using univerified information from an internal website of the vendor (e.g., the TOMI internal website of Hewlett-Packard Company, or another suitable type of internal website), then the designated loss prevention team member can consider (624) in canceling the order 110. The unverified information may be, for example, current information that is store in the internal website of the vendor.

The system of certain embodiments of the invention can be implemented in hardware, software, or a combination thereof. In at least one embodiment, the system is implemented in software or firmware that is stored in a memory and that is executed by a suitable instruction execution system. If implemented in hardware, as in an alternative embodiment, the system can be implemented with any suitable technology as known to those skilled in the art.

The various engines or modules or software discussed herein may be, for example, computer software, commands, data files, programs, code, modules, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or actions will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method of verifying incoming orders for fraud prevention, comprising:
assigning a risk factor with an incoming order; and
providing a set of information to verify based upon the risk factor assigned to the incoming order.

2. The method of claim 1, wherein an incoming order may be associated with one of the risk factor of low risk, medium risk, or high risk.

3. The method of claim 1, further comprising:
prior to assigning the risk factor to the incoming order, outsorting the incoming order into an outsort queue.

4. The method of claim 2, comprising:
verifying the set information to permit a fraud investigation process that requires a lower amount of resource and time, if the incoming order has been associated with the risk factor of low risk.

5. The method of claim 2, comprising:
verifying the set information to permit a fraud investigation process that requires an increased amount of resource and time, if the incoming order has been associated with the risk factor of medium risk.

6. The method of claim 2, comprising:
verifying the set information to permit a fraud investigation process that requires a higher amount of resource and time, if the incoming order has been associated with the risk factor of high risk.

7. The method of claim 4, wherein the action of verifying the set of information comprises:
reviewing an order history of a customer;
reviewing an Internet Protocol address for the order, if the order is received from the Internet;
if the Internet Protocol address is from a vendor that will respond to the order, then searching for a name of the customer in a directory of the vendor;
if the order is received from a call center, then performing an auto-number identification (ANI) search; and
accepting the order if the set of information is verified.

8. The method of claim 5, wherein the action of verifying the set of information comprises:
reviewing an order history of a customer who transmitted the incoming order;
reviewing an Internet Protocol address for the order, if the order is received from the Internet;
if the Internet Protocol address is from a vendor that will respond to the order, then searching for a name of the customer in a directory of the vendor;
if the order is received from a call center, then performing an auto-number identification (ANI) search;
searching for a billing name, billing address, and auto-number identification number in a search tool;
searching a shipping name, shipping address, and shipping phone number in the search tool;
searching the shipping address in an address search tool that can verify information about addresses;
calling a phone number for a bank, if the phone number is available; and
accepting the order if the set of information is verified.

9. The method of claim 8, wherein the search tool is the CHECKPOINT search tool.

10. The method of claim 6, wherein the action of verifying the set of information comprises:
reviewing an order history of a customer who transmitted the incoming order;
reviewing an Internet Protocol address for the order, if the order is received from the Internet;
if the Internet Protocol address is from a vendor that will respond to the order, then searching for a name of the customer in a directory of the vendor;
if the order is received from a call center, then performing an auto-number identification (ANI) number search;
searching for a billing name, billing address, and ANI number in a search tool;
searching a shipping name, shipping address, and shipping phone number in the search tool;
searching the shipping address in an address search tool that can verify information about addresses;
calling a phone number for a bank, if the phone number is available;
searching the billing name and billing address in a second search tool;
searching the ANI number in the second search tool;
permitting a designated loss prevention team member to verify information of the customer with the bank;
permitting a designated loss prevention team member to contact the customer to confirm the order; and
accepting the order if the set of information is verified.

11. The method of claim 10, wherein the second search tool is the SEARCH AMERICA search tool.

12. The method of claim 1, wherein the order is received in a website.

13. The method of claim 1, wherein the order is received in a call center.

14. The method of claim 1, wherein the order is an order for a product.

15. The method of claim 1, wherein the order is an order for a service.

16. An apparatus for verifying incoming orders for fraud prevention, comprising:
a server including a transaction processing module configured to process an incoming order that is received from a call center or an online shopping website, the transaction processing module comprising: an incoming order verification module configured to provide a set of information to verify based upon a risk factor assigned to the incoming order.

17. The apparatus of claim 16, wherein the order risk module associates to an incoming order with one of the risk factor of low risk, medium risk, or high risk.

18. The apparatus of claim 16, wherein the incoming order verification module is configured to verify the set information to permit a fraud investigation process that requires a lower amount of resource and time, if the incoming order has been associated with the risk factor of low risk.

19. The apparatus of claim 16, wherein the incoming order verification module is configured to verify the set information to permit a fraud investigation process that requires an increased amount of resource and time, if the incoming order has been associated with the risk factor of medium risk.

20. The apparatus of claim 16, wherein the incoming order verification module is configured to verify the set information to permit a fraud investigation process that requires a higher amount of resource and time, if the incoming order has been associated with the risk factor of high risk.

21. The apparatus of claim 16, wherein the order is received in a website.

22. The apparatus of claim 16, wherein the order is received in a call center.

23. The apparatus of claim 16, wherein the order is an order for a product.

24. The apparatus of claim 16, wherein the order is an order for a service.

25. An apparatus for verifying incoming orders for fraud prevention, comprising:
means for assigning a risk factor with an incoming order; and
coupled to the assigning means, means for providing a set of information to verify based upon the risk factor assigned to the incoming order.

26. An article of manufacture, comprising:
a machine-readable medium having stored thereon instructions to:
assign a risk factor with an incoming order; and
provide a set of information to verify based upon the risk factor assigned to the incoming order.
